(19) United States
(12) Patent Application Publication
(10) Pub. No.: US 2016/0039072 A1
(43) Pub. Date: Feb. 11, 2016

(54) Gripping Tool with Adjustor Allowing Quick Adjustments of Clamping Pressure Modes

(71) Applicant: Ming Chieh Wu, Taichung City (TW)

(72) Inventor: Ming Chieh Wu, Taichung City (TW)

(21) Appl. No.: 14/453,651

(22) Filed: Aug. 7, 2014

(51) Int. Cl. B25B 7/12

(52) U.S. Cl. CPC B25B 7/123

(57) ABSTRACT

A gripping tool includes a first gripping side and a second gripping side cooperating with the first gripping side. The first gripping side includes a first handle side and a first jaw side fixedly connecting to the first handle side. The second gripping side includes a second handle side and a second jaw side pivotally connecting to the second handle side. The first handle side receives an adjustor. Upon operation of the adjustor, the spacing between the first and second jaw sides can be changed. The adjustor includes a control. The mid section of the first handle side has a largest width defining a first width. The control has a largest width defining a second width. The second width is smaller than the first width. The control includes a hole, and an external tool can engage in the hole to facilitate the operation of adjustor.

### BACKGROUND OF THE INVENTION

1. Field of the Invention

The present invention relates to a gripping tool and, particularly, to a gripping tool with an adjustor design allowing quick adjustments of clamping pressures applied by the gripping tool.

2. Description of the Related Art

TW Pat. No. 239357 shows a gripping tool. A side of a handle of the gripping tool is hollow and includes a sleeve disposed inside. The sleeve includes inner threads. A bolt includes outer threads. The bolt is inserted through and in thread engagement with the sleeve. The bolt can move back and forth in the side of the handle. A user can operate the bolt to adjust the spacing between two jaws of the gripping tool. Since the sleeve can reinforce the side of the handle, the side of the handle does not deform easily. Generally, the user operates the bolt before locking the gripping tool down on an object to be clamped because it is difficult to operate the bolt once the gripping tool is locked.

The present invention is, therefore, intended to obviate or at least alleviate the problems encountered in the prior art.

### SUMMARY OF THE INVENTION

According to the present invention, a gripping tool with an adjustor allowing quick adjustments of clamping pressure modes applied by the gripping tool. The gripping tool includes a first gripping side including a first handle side and a first jaw side. The first handle side has a first and second end and a mid section between the first and second end. The first handle side receives an adjustor. The first handle side includes the second end thereof with inner threads and the adjustor includes outer threads engaging with the inner threads. The adjustor is adapted to be turned. The adjustor moves axially relative to the first handle side along a first phantom axis when being turned. The adjustor includes an end thereof adapted to insert in the mid section of the first handle side. The adjustor includes a control. An outer periphery of the mid section of the first handle side has a largest width defining a first width in a width direction of the gripping tool which is radial to the first phantom axis. An outer periphery of the control has a largest width defining a second width in the width direction of the gripping tool. The second width is smaller than the first width. The control includes a hole extending in a direction transverse to the first phantom axis. The first jaw side has a front end and a rear end. The first end of the first handle side fixedly connects to the rear end of the first jaw side. The first jaw side defines a first clamping edge. A second gripping side includes a second handle side and a second jaw side. The second handle side has a first and second end. The second jaw side has a front end and a rear end. The first end of the second handle side pivotally connects to the rear end of the second jaw side. The second jaw side defines a second clamping edge. The second clamping edge cooperates with and being opposite the first clamping edge. A link includes a first end thereof pivotally connecting to the second handle side and a second end thereof engaging in the mid section of the first handle side and abutting against the adjustor. An elastic member includes a first end thereof connecting to the rear end of the second jaw side and a second end thereof connecting to the first handle side.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

It is therefore an object of the present invention to provide a gripping tool with an adjustor design allowing quick adjustments of clamping pressures applied by the gripping tool.

It is another object of the present invention to provide a gripping tool that a tool can be used

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a gripping tool in accordance with a first embodiment of the present invention.

FIG. 2 is an exploded perspective view of the gripping tool of FIG. 1.

FIG. 3 is a partial, cross-sectional view of the gripping tool of FIG. 1.

FIG. 4 is a top view of the gripping tool of FIG. 1.

FIG. 5 is a side view of the gripping tool of FIG. 1.

FIG. 6 shows the gripping tool of FIG. 1 gripping an object.

FIG. 7 shows an adjustor of the gripping tool of FIG. 1, which is used to adjust the spacing between two jaws of the gripping tool, adjustable by a tool.

### DETAILED DESCRIPTION OF THE INVENTION

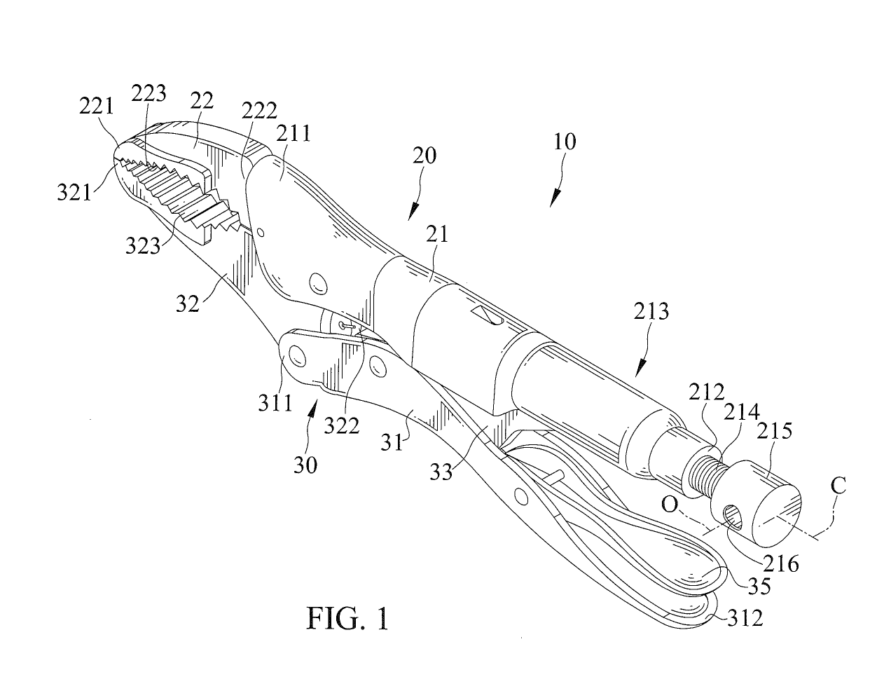

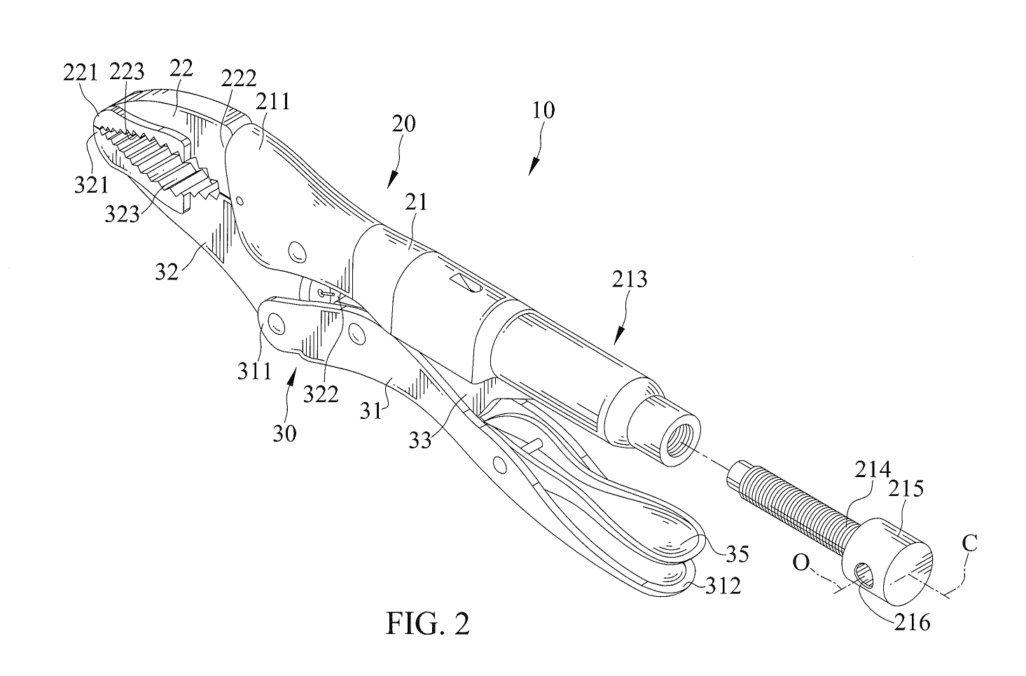

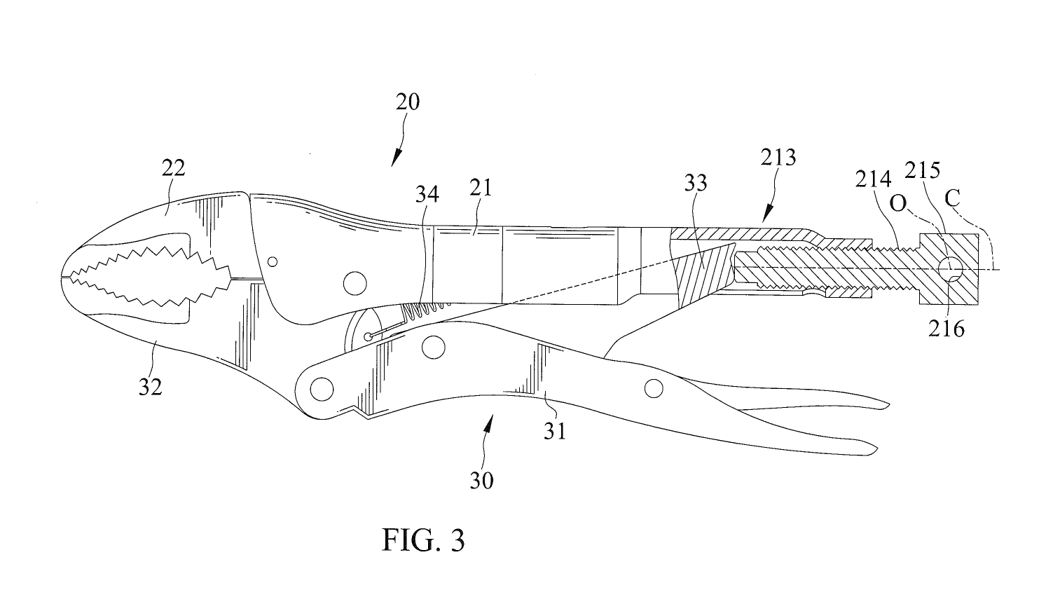

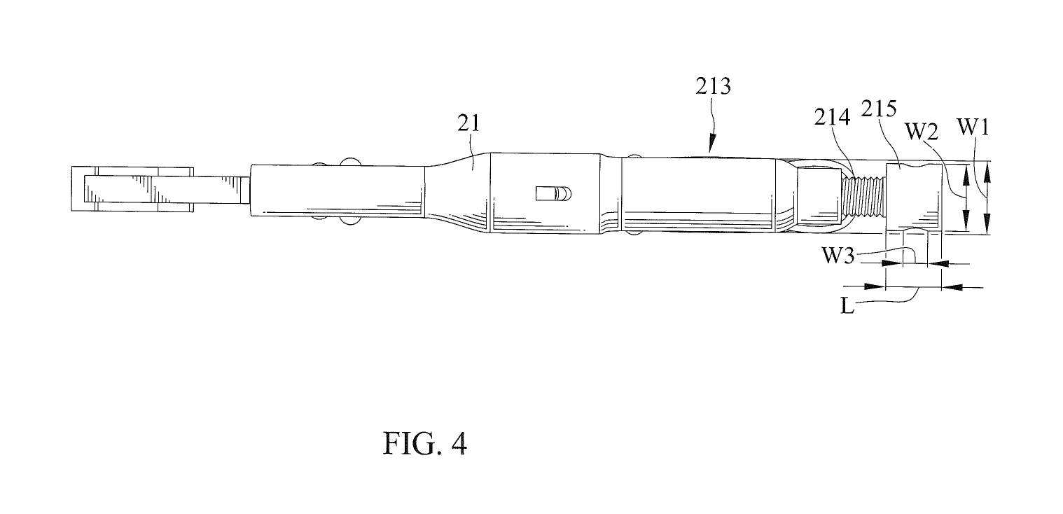

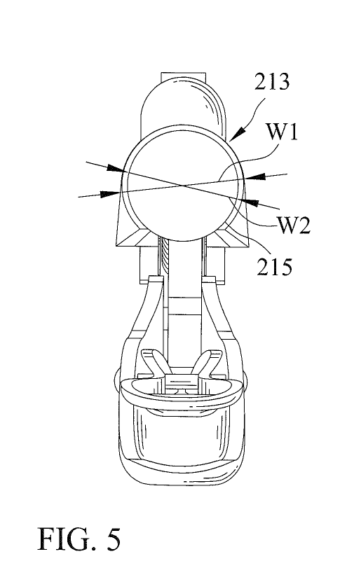

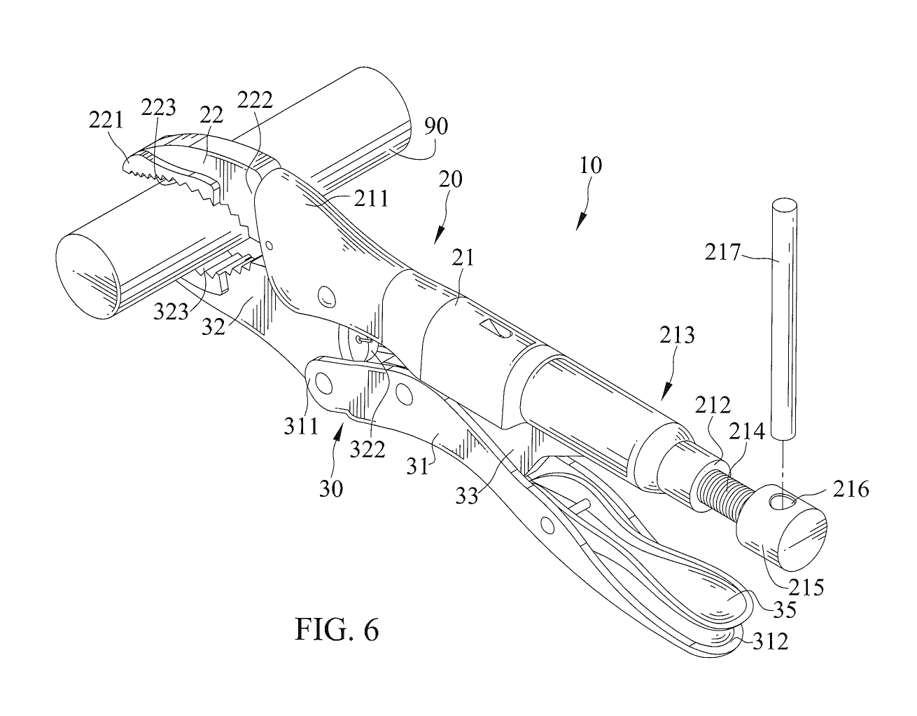

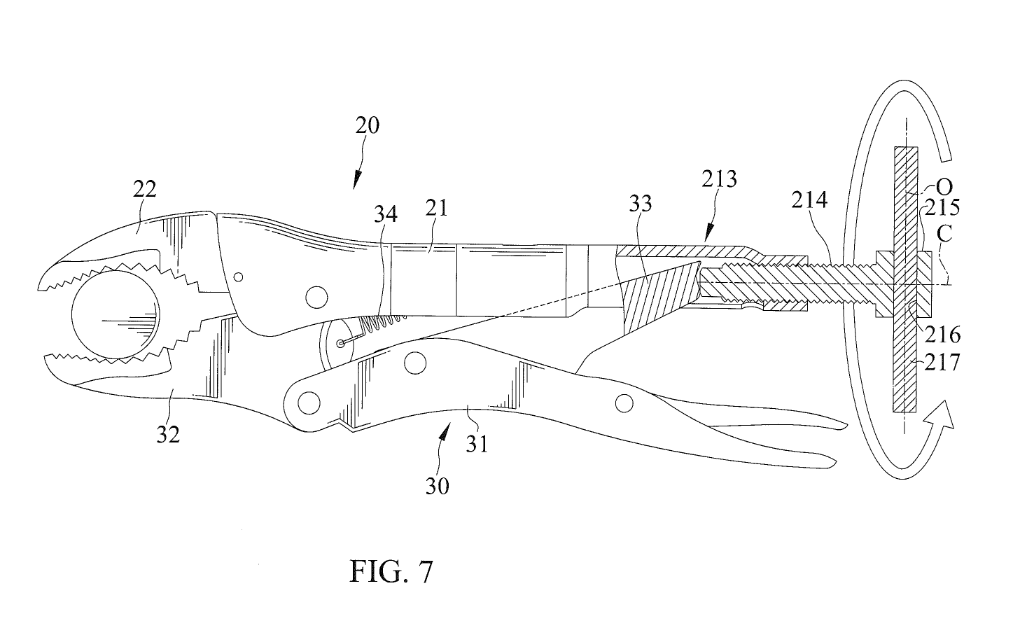

FIGS. 1 through 7 show a gripping tool 10 in accordance with the present invention. The gripping tool 10 is a locking pliers. The gripping tool 10 includes a first and second gripping side 20 and 30.

The first gripping side 20 includes a first handle side 21 and a first jaw side 22. The first handle side 21 has a first and second end 211 and 212 and a mid section 213 between the first and second end 211 and 212. An outer periphery of the mid section 213 of the first handle side 21 has a largest width defining a first width W1 in a width direction of the gripping tool 10 which is radial to the first phantom axis C. The first handle side 21 receives an adjustor 214. The adjustor 214 is a bolt. The adjustor 214 is at the end of the first handle side 21. The first handle side 21 includes the second end 212 thereof with inner threads and the adjustor 214 includes outer threads engaging with the inner threads. The adjustor 214 is adapted to be turned. The adjustor 214 moves axially relative to the first handle side 21 along a first phantom axis C when being turned. The adjustor 214 includes a first end thereof adapted to insert in the mid section 213 of the first handle side 21. The adjustor 214 includes a control 215. The control 215 is disposed outside the first handle side 21. The control 215 has a length L in a length direction of the gripping tool 10 which is along the first phantom axis C. The length L is no less than one half the second width W2. The length L of the control 215 is between one half the second width W2 and the second width W2. An outer periphery of the control 215 has a largest width defining a second width W2 in the width direction of the gripping tool 10. The second width W2 is smaller than the first width W1. The second width W2 is no less than 0.9 times the first width W1. The control 215 is cylindrical in shape. The control 215 includes a hole 216 extending in a direction transverse to the first phantom axis C. The hole 216 is adapted to receive an external tool 217 that facilitates the adjusting operation of adjustor 214, with the external tool 217 providing a leverage to adjust the adjustor 214 easily. The external tool 217 has a longitudinal length extending along the axis O. The hole 216 extends through two lateral sides of the control 215 along an axis O. The axis O is perpendicular to the first phantom axis C. A periphery of the hole 216 has a largest width defining a third width W3 in a direction which is radial to the axis O. The third width W3 is less than one half the second width W2. The third width W3 is between 0.3 times the second width W2 and 0.5 times the second width W2. The first jaw side 22 has a front end 221 and a rear end 222. The first end 211 of the first handle side 21 is fixedly connecting to the rear end 222 of the first jaw side 22. The first jaw side 22 defines a first clamping edge 223. The first clamping edge 223 is serrated and includes a plurality of teeth. The first clamping edge 223 is crescent. The front and rear ends 221 and 222 of the first jaw side 22 and the second end 212 of the first handle side 21 are aligned.

The second gripping side 30 includes a second handle side 31 and a second jaw side 32. The second handle side 31 has a first and second end 311 and 312. The second jaw side 32 has a front end 321 and a rear end 322. The first end 311 of the second handle side 31 pivotally connects to the rear end 322 of the second jaw side 32. The second jaw side 32 defines a second clamping edge 323. The second clamping edge 323 cooperates with and is opposite the first clamping edge 223. The second clamping edge 323 is serrated and includes a plurality of teeth. The second clamping edge 323 is crescent. The front and rear ends 321 and 322 of the second jaw side 32 and the second end 312 of the second handle side 31 are aligned.

A link 33 includes a first end thereof pivotally connecting to the second handle side 31 and a second end thereof engaging in the mid section 213 of the first handle side 21 and abutting against the adjustor 214. The second end of the link 33 abuts against the first end of the adjustor 214. An elastic member 34 includes a first end thereof connecting to the rear end 322 of the second jaw side 32 and a second end thereof connecting to the first handle side 21. The elastic member 34 is a spring. The spring 34 includes a plurality of coaxial loops. The spring 34 is stretched when the gripping tool 10 is unlocked. The spring 34 is compressed when the gripping tool 10 is locked.

The gripping tool 10 has a lock mode in which it is locked and a release mode in which it is unlocked. When the first and second jaw sides 22 and 32 tightly hold an object 90 the gripping tool 10 is in the lock mode. When a spacing between the first and second jaw sides 22 and 32 is greater than that in the lock mode and the object 90 can be released from the gripping tool 10 the gripping tool 10 is in the release mode. The second ends 212 and 312 of the first and second handle sides 21 and 31 allow a user to grasp and to apply a force easily, and by pressing the first and second handle sides 21 and 31 closer together the first and second jaw sides 22 and 23 will move toward one another to hold the object 90. Therefore, the first and second handle sides 21 and 31 are pushed apart to unlock the gripping tool 10. The gripping tool 10 can be unlocked easily by a release leaver 35. The adjustor 214 is used to adjust the spacing between the first and second jaw sides 22 and 32.

Furthermore, the gripping tool 10 includes a release lever 35 to facilitate an unlock operation of the gripping handle 10. The release lever 35 pivotally connects to the second handle side 31. The release lever 35 has a front end adjacent to the first end of the link 33 and a rear end adjacent to the second end 312 of the second handle side 31. A pivot that interconnects the second handle side 31 and the release lever 35 is adjacent to the front end of the release lever 35.

In view of the forgoing, the largest width W1 of the mid section 213 of the first handle side 21 is smaller than the largest width W2 of the control 215. The control 215 includes the hole 216 extending in a direction transverse to the first phantom axis O. The hole 216 extends in the width direction of the gripping tool 10. The control 215 includes the hole 216 extending therethrough. The external tool 217 is adapted to engage in the hole 216 and provide a leverage for a user to turn the adjustor 214, thereby facilitating the operation of adjustor 214, even though the gripping tool 10 is locked. The second width W2 is less than the first width W1, so the volume of adjustor 214 does not cause an adverse effect on the operation of the gripping tool 10. The third width W3 is between 0.3 times the second width W2 and 0.5 times the second width W2, so the adjustor 214 don't deform when it is turned by the external tool 217.

The foregoing is merely illustrative of the principles of this invention and various modifications can be made by those skilled in the art without departing from the scope and spirit of the invention.

What is claimed is:

1. A gripping tool comprising:
a first gripping side including a first handle side and a first jaw side, with the first handle side having a first and second end and a mid section between the first and second end, with the first handle side receiving an adjustor, with the first handle side including the second end thereof with inner threads and the adjustor including outer threads engaging with the inner threads, with the adjustor adapted to be turned, with the adjustor moving axially relative to the first handle side along a first phantom axis when being turned, with the adjustor including an end thereof adapted to insert in the mid section of the first handle side, with the adjustor including a control, with an outer periphery of the mid section of the first handle side having a largest width defining a first width in a width direction of the gripping tool which is radial to the first phantom axis, with an outer periphery of the control having a largest width defining a second width in the width direction of the gripping tool, with the second width being smaller than the first width, with the control including a hole extending in a direction transverse to the first phantom axis, with the first jaw side having a front end and a rear end, with the first end of the first handle side fixedly connecting to the rear end of the first jaw side, and with the first jaw side defining a first clamping edge;
a second gripping side including a second handle side and a second jaw side, with the second handle side having a first and second end, with the second jaw side having a front end and a rear end, with the first end of the second handle side pivotally connecting to the rear end of the second jaw side, with the second jaw side defining a second clamping edge, with the second clamping edge cooperating with and being opposite the first clamping edge;
a link including a first end thereof pivotally connecting to the second handle side and a second end thereof engaging in the mid section of the first handle side and abutting against the adjustor; and
an elastic member including a first end thereof connecting to the rear end of the second jaw side and a second end thereof connecting to the first handle side.

2. The gripping tool as claimed in claim 1, wherein the hole extends through two lateral sides of the control along an axis, and wherein the axis is perpendicular to the first phantom axis.

3. The gripping tool as claimed in claim 1, wherein a periphery of the hole has a largest width defining a third width in a direction which is radial to the axis, and wherein the third width is less than one half the second width.

4. The gripping tool as claimed in claim 1, wherein the second width is no less than 0.9 times the first width.

5. The gripping tool as claimed in claim 3, wherein the third width is between 0.3 times the second width and 0.5 times the second width.

6. The gripping tool as claimed in claim 1, wherein the control has a length in a length direction of the gripping tool which is along the first phantom axis, and wherein the length is no less than one half the second width.

7. The gripping tool as claimed in claim 6, wherein the length of the control is between one half the second width and the second width.

8. The gripping tool as claimed in claim 1, wherein the hole is adapted to receive an external tool that facilitates the adjusting operation of adjustor, with the external tool providing a leverage to adjust the adjustor easily.

9. The gripping tool as claimed in claim 1, wherein the front and rear ends of the first jaw side and the second end of the first handle side are aligned, and wherein the front and rear ends of the second jaw side and the second end of the second handle side are aligned.

10. The gripping tool as claimed in claim 1 further comprising a release lever to facilitate an unlock operation of the gripping handle, and wherein the release lever pivotally connects to the second handle side.

11. The gripping tool as claimed in claim 1, wherein each of the first and second clamping edges of the first and second jaw sides is serrated and includes a plurality of teeth.

12. The gripping tool as claimed in claim 11, wherein each of the first and second clamping edges of the first and second jaw sides is crescent.

13. The gripping tool as claimed in claim 1, wherein the elastic member is a spring.

14. The gripping tool as claimed in claim 1, wherein the control is cylindrical in shape.

15. The gripping tool as claimed in claim 3, wherein the control has a length in a length direction of the gripping tool which is along the first phantom axis, and wherein the length is no less than one half the second width.

16. The gripping tool as claimed in claim 8, wherein the hole extends through two lateral sides of the control along an axis, and wherein the axis is perpendicular to the first phantom axis.

17. The gripping tool as claimed in claim 8, wherein a periphery of the hole has a largest width defining a third width in a direction which is radial to the axis, and wherein the third width is less than one half the second width.

18. The gripping tool as claimed in claim 17, wherein the control has a length in a length direction of the gripping tool which is along the first phantom axis, and wherein the length is no less than one half the second width.

19. The gripping tool as claimed in claim 18 further comprising a release lever to facilitate an unlock operation of the gripping handle, and wherein the release lever pivotally connects to the second handle side.
